(19) United States
(12) Patent Application Publication
(10) Pub. No.: US 2025/0211094 A1
(43) Pub. Date: Jun. 26, 2025

(54) POWER CONVERSION DEVICE

(71) Applicant: SANDEN CORPORATION, Isesaki-shi, Gunma (JP)

(72) Inventors: Kohei TAKADA, Isesaki-shi, Gunma (JP); Tatsuki KASHIHARA, Isesaki-shi, Gunma (JP); Koji KOBAYASHI, Isesaki-shi, Gunma (JP)

(21) Appl. No.: 18/844,895

(22) PCT Filed: Feb. 16, 2023
(86) PCT No.: PCT/JP2023/005384

§ 371 Date: Sep. 6, 2024

(30) Foreign Application Priority Data
Mar. 18, 2022 (JP) 2022-043832

(51) Int. Cl. H02M 1/12; H02M 1/44; H02M 7/00; H02M 7/5387; H02P 27/08

(52) U.S. Cl. CPC H02M 1/123; H02M 1/44; H02M 7/003; H02M 7/53875; H02P 27/08

(57) ABSTRACT

There is provided a power conversion device capable of easily reducing noise (common mode current) flowing out from a switching element via a parasitic capacitance. A power conversion device 1 applies a voltage at a connection point of upper and lower arm switching elements 18A to 18F to a motor 8. A parasitic capacitance between each of the lower arm switching elements 18D to 18F and a chassis 2 (partition wall 3: heatsink) is smaller than a parasitic capacitance between each of the upper arm switching elements 18A to 18C and the chassis 2 (partition wall 3: heatsink). Alternatively, a dielectric constant between each of the lower arm switching elements 18D to 18F and the chassis 2 (partition wall 3: heatsink) is smaller than a dielectric constant between each of the upper arm switching elements 18A to 18C and the chassis 2 (partition wall 3: heatsink).

### TECHNICAL FIELD

The present invention relates to a power conversion device which applies a voltage at a connection point of upper and lower arm switching elements to a load.

### BACKGROUND ART

Conventionally, this type of power conversion device connects an upper arm switching element (such as an IGBT) and a lower arm switching element (such as an IGBT) in series between a positive side power supply line and a negative side power supply line and connects this connection point (arm midpoint) to a load such as a motor of an electric compressor. Then, the power conversion device has been configured to control the switching of each switching element to thereby apply the AC-converted voltage to the load for driving it (refer to, for example, Patent Document 1 and Patent Document 2).

### CITATION LIST

### Patent Documents

Patent Document 1: Japanese Patent Application Laid-Open No. Hei 4 (1992)-242997

Patent Document 2: Japanese Patent No. 5030551

### SUMMARY OF THE INVENTION

### Problems to Be Solved by the Invention

Here, this type of power conversion device, particularly a three-phase inverter circuit involves much noise flowing out through a parasitic capacitance between the arm midpoint of each switching element and a chassis. Therefore, there has been taken a noise reduction measure of installing a large EMI filter at an input part of a control circuit and circulating noise (common mode current) flowing out to the chassis (e.g., a housing of an electric compressor) via a parasitic capacitance from a noise source (switching element) back to the noise source using a common mode coil and a Y capacitor. However, in this method, the length of the wiring to the EMI filter is long, thereby making it difficult to obtain a sufficient filtering effect of the Y capacitor against noise (common mode current) which flows from the switching element being the noise source to the chassis. Therefore, it was necessary to insert a large common mode coil having a sufficient impedance.

The present invention has been made to solve such conventional technical problems, and it is an object of the present invention to provide a power conversion device capable of easily reducing noise (common mode current) flowing out from a switching element via a parasitic capacitance.

### Means for Solving the Problems

A power conversion device of the invention of claim 1 is characterized by applying a voltage at a connection point of upper and lower arm switching elements to a load, and in that a parasitic capacitance between the lower arm switching element and a heatsink is smaller than a parasitic capacitance between the upper arm switching element and the heatsink.

A power conversion device of the invention of claim 2 is characterized by applying a voltage at a connection point of upper and lower arm switching elements to a load, and in that a dielectric constant between the lower arm switching element and a heatsink is smaller than a dielectric constant between the upper arm switching element and the heatsink.

The power conversion device of the invention of claim 3 is characterized in the above respective inventions by including sheets interposed between the upper and lower arm switching elements and the heatsink, and in that the sheet interposed between the lower arm switching element and the heatsink is larger in thickness dimension than the sheet interposed between the upper arm switching element and the heatsink.

The power conversion device of the invention of claim 4 is characterized in the above invention by including a control device which controls switching of the upper and lower arm switching elements, and in that the control device makes a conduction time of the upper arm switching element longer than a conduction time of the lower arm switching element.

The power conversion device of the invention of claim 5 is characterized in the above invention by including the upper and lower arm switching elements of multiple phases, and in that the control device adds an equal voltage to a command voltage for switching the upper and lower arm switching elements of each phase to make the conduction time of the upper arm switching element longer.

The power conversion device of the invention of claim 6 is characterized in that in the above invention, the control device includes a bootstrap capacitor for switching the upper arm switching element, and controls the voltage to be added to secure a charging time for the bootstrap capacitor.

The power conversion device of the invention of claim 7 is characterized in the invention of claim 1 or 2 by including a cooling device which cools the upper and lower arm switching elements, and in that the lower arm switching element is arranged so as to receive a stronger cooling effect from the cooling device than the upper arm switching element.

The power conversion device of the invention of claim 8 is characterized in the invention of claim 1 or 2 by applying a phase voltage at a connection point of the three-phase upper and lower arm switching elements to a motor which drives a compression mechanism of an electric compressor, and in that the upper and lower arm switching elements of each phase are arranged in a heat exchange relation with a refrigerant sucked into the electric compressor, and the lower arm switching element is arranged on the upstream side of the sucked refrigerant than the upper arm switching element.

The power conversion device of the invention of claim 9 is characterized in the invention of claim 3 by including the upper and lower arm switching elements of multiple phases, and in that the thickness of the sheet is set by using the ratio between a wiring length between each of the upper and lower arm switching elements of each phase and a smoothing capacitor and the parasitic capacitance between the lower arm switching element and the heatsink.

The power conversion device of the invention of claim 10 is characterized in that in the above invention, the impedance of an inductance of a path from a DC power supply to each of the upper and lower arm switching elements of each phase, and the impedance of a parasitic capacitance between each of the upper and lower arm switching elements and the heatsink are balanced.

### Advantageous Effect of the Invention

Normally, switching elements such as IGBTs each have a heat spreader on a collector electrode (in the case of an IGBT) to increase heat dissipation efficiency. Almost all high-voltage and large-current switching elements correspond to this structure. Then, the heat spreader is connected to a heatsink (for example, a housing of an electric compressor) via insulation or an insulating sheet. For example, in the case of a three-phase inverter, six switching elements are connected to the same heatsink for heat dissipation.

With the sheet having a constant dielectric constant, when the collector electrode is connected to the heat spreader, the structure between the collector electrode and the heatsink is the same as that of a parallel plate capacitor, and there is a large parasitic capacitance (intermediate capacitance) of several tens of pF to several hundreds of pF at an arm midpoint which adversely affects EMI noise, i.e., between the collector electrode of the lower arm switching element and the heatsink.

Therefore, according to the invention of claim 1 or 2, in the power conversion device which applies the voltage at the connection point of the upper and lower arm switching elements to the load, the parasitic capacitance between the lower arm switching element and the heatsink is made smaller than that between the upper arm switching element and the heatsink, or the dielectric constant between the lower arm switching element and the heatsink is made smaller than that between the upper arm switching element and the heatsink. This therefore makes it possible to significantly reduce EMI noise due to a common mode current flowing out from the arm midpoint.

In particular, as in the invention of claim 3, the thickness dimension of the sheet interposed between the lower arm switching element and the heatsink is made larger than that of the sheet interposed between the upper arm switching element and the heatsink. This therefore makes it possible to easily and inexpensively realize a reduction in EMI noise.

When the thickness dimension of the sheet is made large here, the heat dissipation performance of the lower arm switching element is deteriorated. Therefore, as in the invention of claim 4, the conduction time of the upper arm switching element is made longer than that of the lower arm switching element by the control device. It is thus possible to concentrate the generation of heat in the upper arm switching element, suppress the generation of heat in the lower arm switching element, and compensate for the deterioration of the heat dissipation performance caused by enlargement in the thickness dimension of the sheet.

In this case, as in the invention of claim 5, the control device adds the equal voltage to the command voltage for switching the upper and lower arm switching elements of each phase, thereby making it possible to make the conduction time of the upper arm switching element longer.

Incidentally, when the conduction time of the upper arm switching element is lengthened as described above, the charging time of the bootstrap capacitor for switching the upper arm switching element becomes shorter. However, as in the invention of claim 6, if the control device controls the voltage to be added to ensure the charging time of the bootstrap capacitor, the switching of the upper arm switching element can also be performed without hindrance.

Further, it is possible to solve the problem associated with the deterioration of the heat dissipation performance of the lower arm switching element by arranging the lower arm switching element so as to receive a stronger cooling effect from the cooling device than the upper arm switching element as in the invention of claim 7.

For example, when the power conversion device applies the phase voltage to the motor which drives the compression mechanism of the electric compressor, as in the invention of claim 8, the upper and lower arm switching elements of each phase are arranged in a heat exchange relation with the refrigerant sucked into the electric compressor, and the lower arm switching element is arranged on the upstream side of the sucked refrigerant than the upper arm switching element, thereby making it possible to solve the problem associated with the deterioration of the heat dissipation performance of the lower arm switching element.

Further, as in the invention of claim 9, the thickness of the sheet is set by using the ratio between the wiring length between the upper and lower arm switching elements of each phase and the smoothing capacitor and the parasitic capacitance between the lower arm switching element and the heatsink, thereby making it easier to balance the impedance as in the invention of claim 10 and making it possible to effectively reduce EMI noise.

### BRIEF DESCRIPTION OF THE DRAWINGS

FIG. 1 is an electric circuit diagram of a power conversion device according to one embodiment of the present invention.

FIG. 2 is a longitudinal cross-sectional side view of an electric compressor of one embodiment provided with the power conversion device of FIG. 1.

FIG. 3 is a side view of the electric compressor of FIG. 2 as viewed from the side of an inverter housing part except for a cover and a substrate.

FIG. 4 is an enlarged cross-sectional view of a main part of the electric compressor of FIG. 2 describing a mounting structure of upper and lower arm switching elements.

FIG. 5 is a diagram describing an internal structure of the upper arm switching element and its mounting structure.

FIG. 6 is a diagram describing an internal structure of the lower arm switching element and its mounting structure.

FIG. 7 is a diagram showing parasitic capacitances between the upper and lower arm switching elements and a chassis.

FIG. 8 is a diagram showing sinusoidal modulation pulse width command values when performing sinusoidal modulation control of a motor.

FIG. 9 is a diagram showing the magnitude of currents flowing through the upper arm switching element and lower arm switching element of the U phase in FIG. 8 when the voltage and current phases are equal.

FIG. 10 is a diagram showing discontinuous modulation pulse width command values of each phase.

FIG. 11 is a diagram showing the magnitude of currents flowing through the upper arm switching element and lower arm switching element of the U phase in FIG. 10 when the voltage and current phases are equal.

FIG. 12 is a diagram describing the operation of generating a PWM signal by a PWM signal generation unit.

FIG. 13 is a diagram describing the results of measurement of EMI noise.

FIG. 14 is a diagram describing the difference between the two measurement results shown in FIG. 13.

FIG. 15 is a diagram showing an internal configuration of a gate driver shown in FIG. 1.

FIG. 16 is a diagram showing discontinuous modulation pulse width command values of each phase when zero-phase voltage addition control is performed.

FIG. 17 is a diagram showing the magnitude of currents flowing through the U-phase upper arm switching element and lower arm switching element in the case of FIG. 16.

### MODE FOR CARRYING OUT THE INVENTION

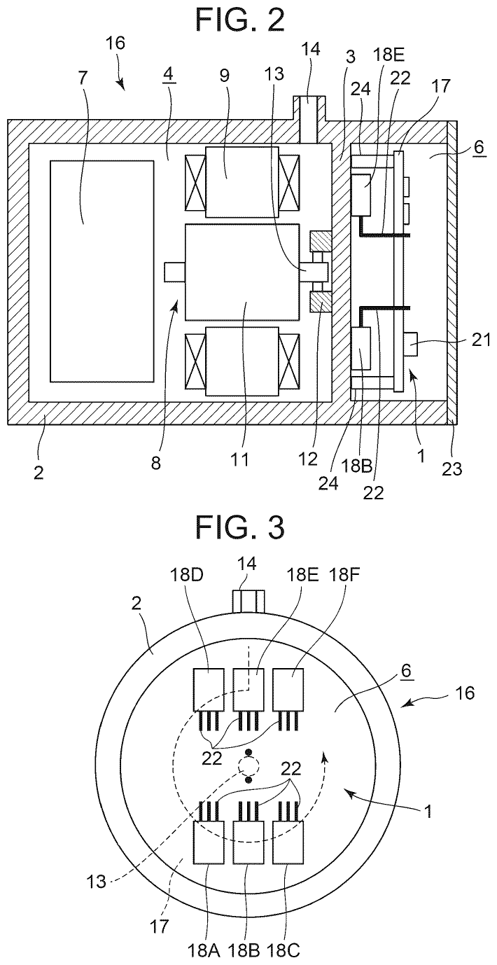

Hereinafter, embodiments of the present invention will be described in detail based on the drawings. First, an electric compressor (inverter-integrated electric compressor) 16 according to an embodiment integrally provided with a power conversion device 1 of the present invention will be described with reference to FIG. 2 and FIG. 3, Incidentally, the electric compressor 16 according to the embodiment constitutes a part of a refrigerant circuit of a vehicle air conditioning device mounted on an electric vehicle.

### (1) Configuration of Electric Compressor 16

In FIG. 2, the inside of a metallic chassis 2 (heatsink) of the electric compressor 16 is partitioned into a compression mechanism housing part 4 and an inverter housing part 6 by a partition wall 3 (part of the chassis 2) intersecting an axial direction of the chassis 2, For example, a scroll-type compression mechanism 7 and a motor 8 (load) which drives this compression mechanism 7 are accommodated in the compression mechanism housing part 4. In this case, the motor 8 is an IPMSM (Interior Permanent Magnet Synchronous Motor) constituted of a stator 9 fixed to the chassis 2 and a rotor 11 which rotates inside the stator 9.

A bearing portion 12 is formed at the central portion of the partition wall 3 on the compression mechanism housing part 4 side, One end of a drive shaft 13 of the rotor 11 is supported by the bearing portion 12, and the other end of the drive shaft 13 is linked to the compression mechanism 7. A suction port 14 is formed in the vicinity of the partition wall 3 at a position corresponding to the compression mechanism housing part 4 of the chassis 2. When the rotor 11 (drive shaft 13) of the motor 8 is rotated to drive the compression mechanism 7, a low temperature refrigerant which is a working fluid, flows from the suction port 14 into the compression mechanism housing part 4 of the chassis 2 and is sucked into and compressed by the compression mechanism 7.

Then, the refrigerant compressed by the compression mechanism 7 and brought to a high temperature and high pressure is configured to be discharged from an unshown discharge port to the refrigerant circuit outside the chassis 2. Further, since the low temperature refrigerant flowing from the suction port 14 passes near the partition wall 3 and passes around the motor 8, and is sucked by the compression mechanism 7, the partition wall 3 is also cooled.

And then, the power conversion device 1 of the present invention which drives and controls the motor 8 (load) is housed in the inverter housing part 6 partitioned from the compression mechanism housing part 4 by the partition wall 3. In this case, the power conversion device 1 is configured to supply power to the motor 8 through a sealing terminal and a lead wire penetrating the partition wall 3.

### (2) Structure of Power Conversion Device 1 (Arrangement of Upper and Lower Arm Switching Elements 18A to 18F)

In the case of the embodiment, the power conversion device 1 is constituted of a substrate 17, six upper and lower arm switching elements 18A to 18F wired on one surface side of the substrate 17, a control section 21 wired on the other surface side of the substrate 17, an HV connector, an LV connector, etc. which are not shown in the drawing. In the embodiment, the switching elements 18A to 18F are each constituted of an insulated gate bipolar transistor (IGBT) in which a MOS structure is incorporated in a gate portion.

In this case, in the embodiment, three of an upper arm switching element 18A of a U-phase inverter 190, an upper arm switching element 18B of a V-phase inverter 19V, and an upper arm switching element 180 of a W-phase inverter 19W in a three-phase inverter circuit (three-phase inverter circuit) 28 to be described later, and three of a lower arm switching element 18D of the U-phase inverter 190, a lower arm switching element 18E of the V-phase inverter 19V, and a lower arm switching element 18F of the W-phase inverter 19W in the three-phase inverter circuit 28 are respectively arranged side by side on the substrate 17 as shown in FIG. 3.

In this case, in the embodiment, the lower arm switching element 18D of the U-phase inverter 19U, the lower arm switching element 18E of the V-phase inverter 19V, and the lower arm switching element 18F of the W-phase inverter 19W are located on the suction port 14 side. The upper arm switching element 18A of the U-phase inverter 190, the upper arm switching element 18B of the V-phase inverter 19V, and the upper arm switching element 18C of the w-phase inverter 19W are arranged at a position opposite to the suction port 14.

Then, the refrigerant sucked through the suction port 14 rotates counterclockwise about the axis of the chassis 2 as indicated by a broken line arrow in FIG. 3. Therefore, the lower arm switching element 18D of the U-phase inverter 190, the lower arm switching element 18E of the V-phase inverter 19V, and the lower arm switching element 18F of the W-phase inverter 19W are located on the upstream side (location subjected to a strong cooling effect in the present invention) with respect to the flow of the suction refrigerant, The upper arm switching element 18A of the U-phase inverter 190, the upper arm switching element 18B of the V-phase inverter 19V, and the upper arm switching element 18C of the W-phase inverter 19W are arranged on the downstream side of the location. Terminal portions 22 of the respective switching elements 18A to 18F are connected to the substrate 17 in a state in which they are located on the central side of the substrate 17.

Then, the power conversion device 1 assembled in this manner is accommodated in the inverter housing part 6 in a state in which one surface side of the respective switching elements 18A to 18F being present serves as the partition wall 3 side, attached to the partition wall 3 and closed with a cover 23. In this case, the substrate 17 is fixed to the partition wall 3 via boss portions 24 which stand up from the partition wall 3.

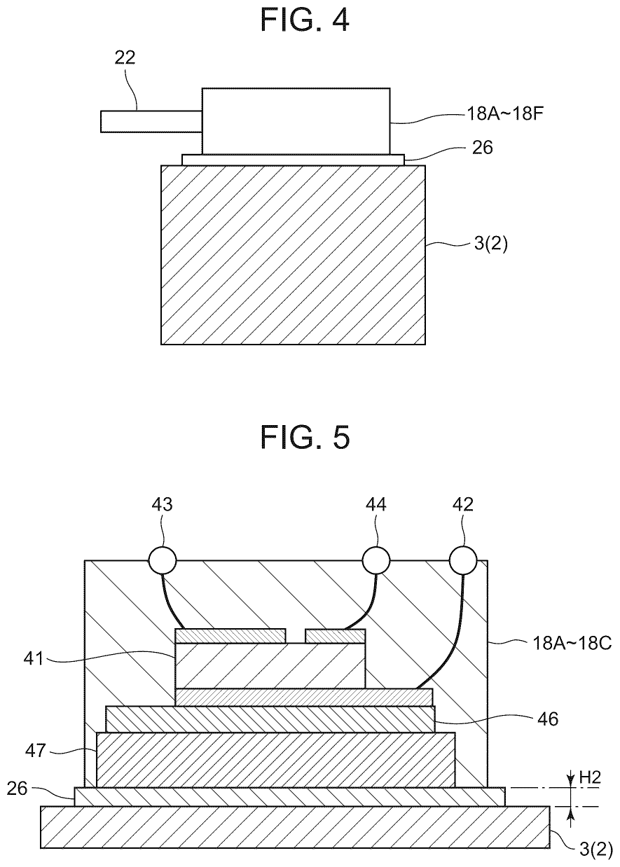

Thus, in the state in which the power conversion device 1 is attached to the partition wall 3, the respective switching elements 18A to 18F are in close contact with the partition wall 3 via an insulating and/or heat dissipating sheet 26 as shown in FIG. 4 and have a heat exchange relation with the partition wall 3 of the chassis 2. At this time, the respective switching elements 18A to 18F are arranged at positions avoiding locations corresponding to the bearing 12 and the drive shaft 13 (FIG. 3).

Further, since the partition wall 3 is cooled by the refrigerant sucked into the compression mechanism housing part 4 as described above, the respective switching elements 18A to 18F are in a heat exchange relation with the sucked refrigerant via the partition wall 3 and cooled by the refrigerant sucked into the compression mechanism housing part 4 via the partition wall 3. The respective switching elements 18A to 18F themselves dissipate heat to the refrigerant via the partition wall 3. That is, the partition wall 3 (part of the chassis 2) of the electric compressor 16 becomes an embodiment of the heatsink and the cooling device in the present invention.

### (3) Internal Structure of Upper and Lower Arm Switching Elements 18A to 18F and Their Mounting Structures

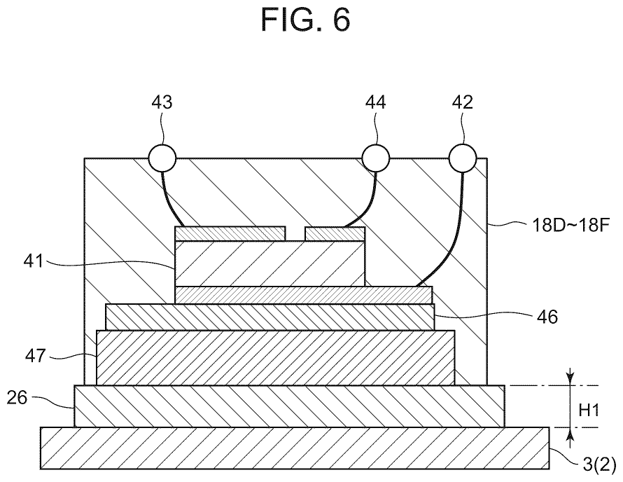

In the embodiment, the upper and lower arm switching elements 18A to 18F comprised of IGBTs all have the same structure. As shown in FIGS. 5 and 6, each of the upper and lower arm switching elements is comprised of an IGBT element Al made of a semiconductor, a collector electrode 42, an emitter electrode 43, a gate electrode 44, and a heat spreader 47 connected to the collector electrode 42 via an insulating layer 46. Further, the heat spreader 47 is attached in close contact with the partition wall 3 (chassis 2) via the above-described sheet 26.

In this case, in the embodiment, the thickness dimension H1 of the sheet 26 interposed between the lower arm switching elements 18D to 18F and the partition wall 3 (FIG. 6) is set to a value larger than the thickness dimension H2 (FIG. 5) of the sheet 26 interposed between the upper arm switching elements 18A to 18C and the partition wall 3 (H2<H1). Since the sheet 26 has a prescribed dielectric constant inversely proportional to the thickness, with this configuration, the dielectric constant between the lower arm switching elements 18D to 18F and the partition wall 3 (chassis 2: heatsink) is set smaller than the dielectric constant between the upper arm switching elements 18A to 18C and the partition wall 3, In other words, the parasitic capacitance between the lower arm switching elements 18D to 18F and the partition wall 3 (chassis 2: heatsink) becomes smaller than the parasitic capacitance between the upper arm switching elements 18A to 18C and the partition wall 3.

### (4) Circuit Configuration of Power Conversion Device 1

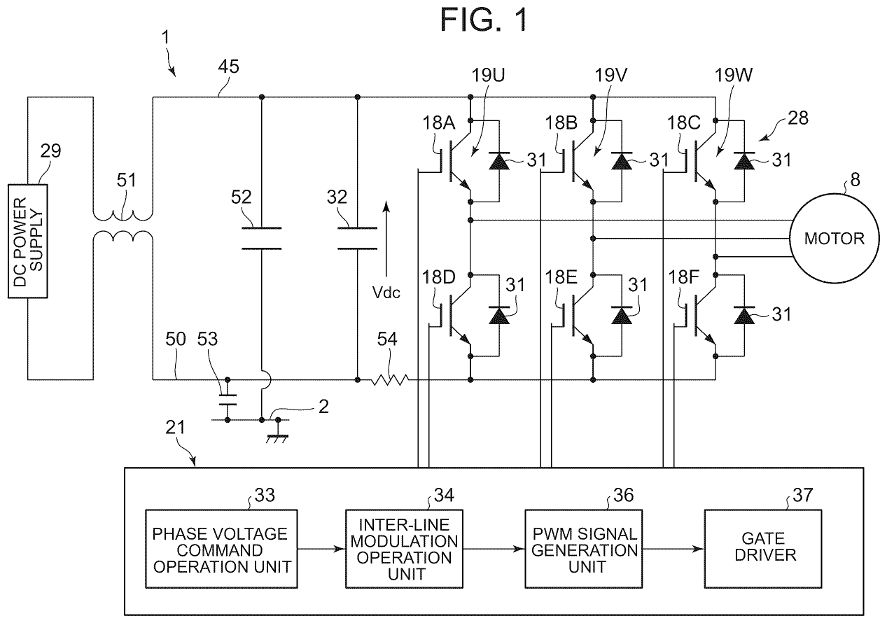

Next, in FIG. 1, the power conversion device 1 includes the above-described three-phase inverter circuit (three-phase inverter circuit) 28 and control section 21. The inverter circuit 28 is a circuit which converts a DC voltage (e.g., DC300V) of a DC power supply (battery of an electric vehicle) 29 into a three-phase AC voltage and applies the same to an armature coil of the stator 9 of the motor 8, The inverter circuit 28 has the above-described U-phase inverter 19U, V-phase inverter 19V and w-phase inverter 19W, The phase inverters 190 to 19W respectively have the above-described upper arm switching elements 18A to 18C and lower arm switching elements 18D to 18F individually. Further, flywheel diodes 31 are connected in antiparallel to the switching elements 18A to 18F respectively.

Then, the collector electrodes 42 of the upper arm switching elements 18A to 18C of the inverter circuit 28 are connected to the DC power supply 29 and a positive side power supply line 45 (HV+) of a smoothing capacitor 32, Incidentally, although the smoothing capacitor 32 is also provided on the substrate 17 to constitute the power conversion device 1, it is not shown in FIGS. 2 and 3 in order to make the arrangement of the switching elements 18A to 18F easy to understand. On the other hand, the emitter electrodes 43 of the lower arm switching elements 18D to 18F of the inverter circuit 28 are connected to the DC power supply 29 and a negative side power supply line 50 (HV−) of the smoothing capacitor 32,

Then, the emitter electrode 43 of the upper arm switching element 18A of the U-phase inverter 190 and the collector electrode 42 of the lower arm switching element 18D thereof are connected, and their connection point (arm midpoint) is connected to the U-phase armature coil of the motor 8. Also, the emitter electrode 43 of the upper arm switching element 18B of the V-phase inverter 19V and the collector electrode 42 of the lower arm switching element 18E thereof are connected, and their connection point (arm midpoint) is connected to the V-phase armature coil of the motor 8, Further, the emitter electrode 43 of the upper arm switching element 18C of the W-phase inverter 19W and the collector electrode 42 of the lower arm switching element 18F thereof are connected, and their connection point (arm midpoint) is connected to the W-phase armature coil of the motor 8.

In the figure, designated at 51 is a common mode coil, which is connected to a subsequent stage of the DC power supply 29. Designated at 52 and 53 are Y capacitors. The Y capacitor 52 is connected between the positive side power supply line 45 and the chassis 2, and the Y capacitor 53 is connected between the negative side power supply line 50 and the chassis 2, respectively, These common mode coil 51 and Y capacitors 52 and 53 constitute an EMI filter. Further, designated at 54 is a shunt resistor, which is connected to the negative side power supply line 50 and used to detect the phase current of the motor 8.

### (5) Parasitic Capacitance Between Collector Electrodes 42 of Upper and Lower Arm Switching Elements 18A to 18F and Chassis 2

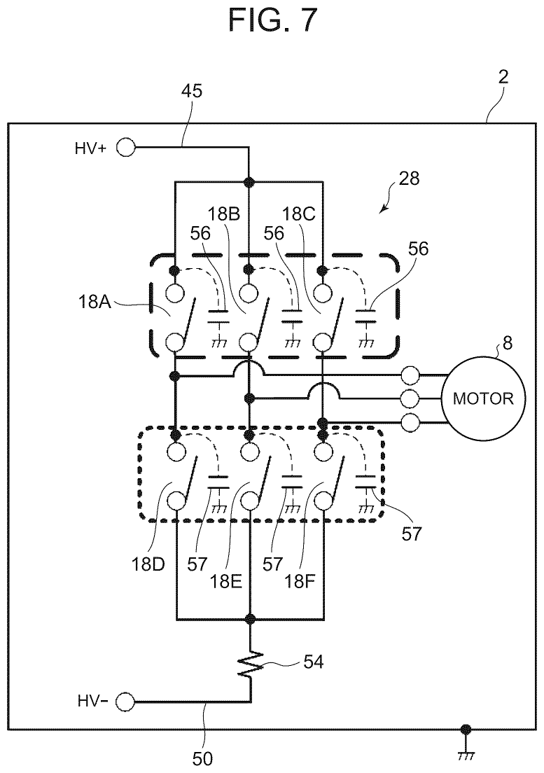

FIG. 7 shows a parasitic capacitance between each of the upper and lower arm switching elements 18A to 18F and the chassis 2 (partition wall 3). In the figure, designated at 56 is a parasitic capacitance between the collector electrode 42 of each of the upper arm switching elements 18A to 180 and the chassis 2, which has a value of about several tens to several hundred pF. Designated at 57 is a parasitic capacitance between the collector electrode 42 (arm midpoint) of each of the lower arm switching elements 18D to 18F and the chassis 2, which also has a value of about several tens to several hundred pF. As described above, since there is a large amount of common mode current (noise) flowing out via the parasitic capacitances 57 between the collector electrodes 42 (arm midpoints) of these lower arm switching elements 18D to 18F and the chassis 2, in the embodiment, as described above, the thickness dimension H1 of the sheet 26 for the lower arm switching elements 18D to 18F is made large, but on the other hand, the effect thereof will be described in detail later,

### (6) Configuration of Control Section 21

Next, the control section 21 is configured of a microcomputer having a processor. The control section 21 receives a rotation speed command value from an electric vehicle ECU, receives a phase current of the motor 8 from a shunt resistor 54, and controls ON/OFF states of the switching elements 18A to 18F of the inverter circuit 28, based on these. Specifically, the control section 21 controls a gate voltage applied to the gate electrode 44 of each of the switching elements 18A to 18F.

The control section 21 has a phase voltage command operation unit 33, an inter-line modulation operation unit 34, a PWM signal generation unit 36, and a gate driver 37. The phase voltage command operation unit 33 calculates PWM sinusoidal modulation pulse width command values Cu (U-phase pulse width command value), Cv (V-phase pulse width command value), and Cw (W-phase pulse width command value) each of which is applied to the armature coil of each phase of the motor 8, based on the electrical angle, current command value and phase current of the motor 8.

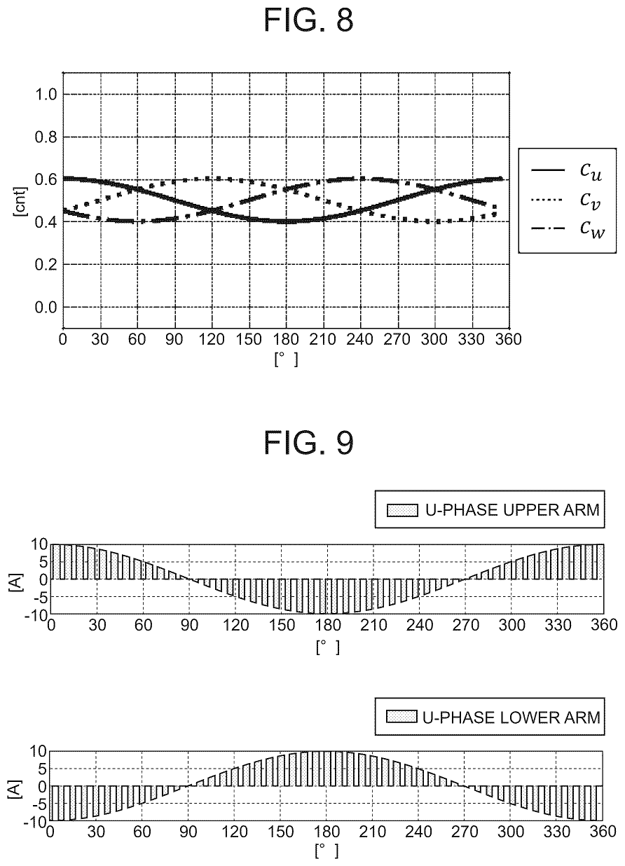

The sinusoidal modulation pulse width command values Cu, Cv, and Cw are values after normalization (after correction to 0 to 1) of the voltage command value when performing sinusoidal modulation control of the motor 8, and are shown in FIG. 8 (modulation rate 0.2). Further, FIG. 9 shows the magnitude of the current flowing through the U-phase upper arm switching element 18A and lower arm switching element 18D when the voltage and current phases are equal (current in the direction from the collector electrode 42 to the emitter electrode 43).

The inter-line modulation operation unit 34 calculates discontinuous modulation pulse width command values Cu′ (U-phase pulse width command value), Cv′ (V-phase pulse width command value), and Cw′ (W-phase pulse width command value) on the basis of the sinusoidal modulation pulse width command values Cu, Cv, and Cw operated and calculated from the phase voltage command operation unit 33. The inter-line modulation operation unit 34 adds an equal voltage (an arbitrary zero-phase voltage of 0 or more) to the sinusoidal modulation pulse width command values Cu, Cv, and Cw of each phase to generate discontinuous modulation pulse width command values Cu′, Cv′, and Cw′ of each phase.

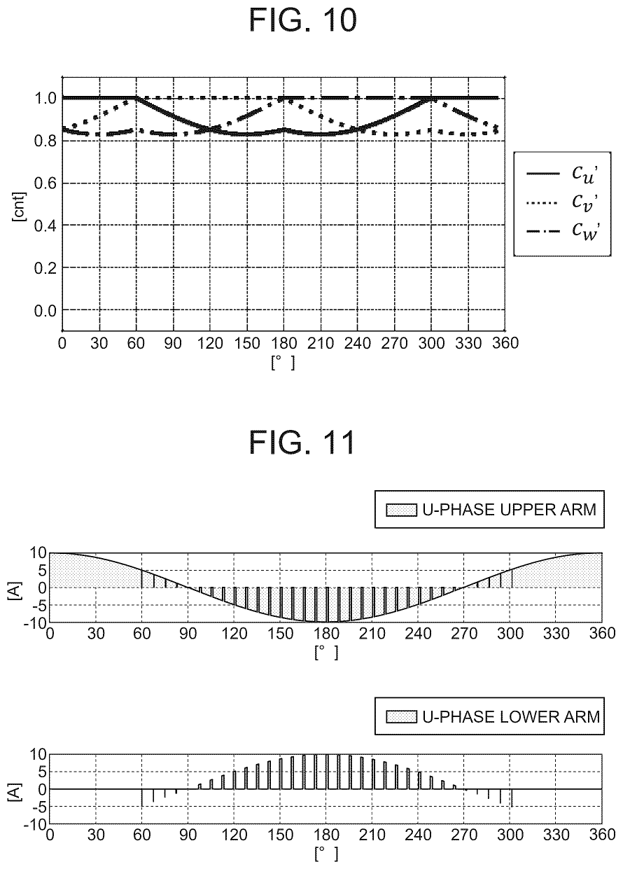

In the embodiment, for the U phase, the voltage is added so that the discontinuous modulation pulse width command value Cu′ becomes 1 at the phases of 0° to 60° and 300° to 360°. For the V phase, the voltage is applied so that the discontinuous modulation pulse width command value Cv′ becomes 1 at the phases of 60° to 180°. For the W phase, the voltage is applied so that the discontinuous modulation pulse width command value Cw′ becomes 1 at the phases of 180° to 300°. This situation is shown in FIG. 10 (indicating a state in which the zero-phase voltage is added up to the maximum).

Thus, in the phases of 0° to 60° and 300° to 360°, the U-phase upper arm switching element 18A remains turned ON, and the U-phase lower arm switching element 18D remains turned OFF. Also, in the phases of 60° to 180°, the V-phase upper arm switching element 18B remains turned ON, and the V-phase lower arm switching element 18E remains turned OFF. Further, in the phases of 180° to 300°, the W-phase upper arm switching element 180 remains turned ON, and the W-phase lower arm switching element 18F remains turned OFF. Then, in any phase, switching is performed by the upper and lower arm switching elements of the other two phases (discontinuous modulation).

FIG. 11 shows the magnitude of the current flowing through each of the U-phase upper arm switching element 18A and lower arm switching element 18D in the above case. Thus, the conduction time of the upper arm switching element 18A becomes longer than the conduction time of the lower arm switching element 18D. The generation of heat is concentrated in the upper arm switching element 18A, and the generation of heat of the lower arm switching element 18D is reduced. The same applies even to the other V-phase and W-phase.

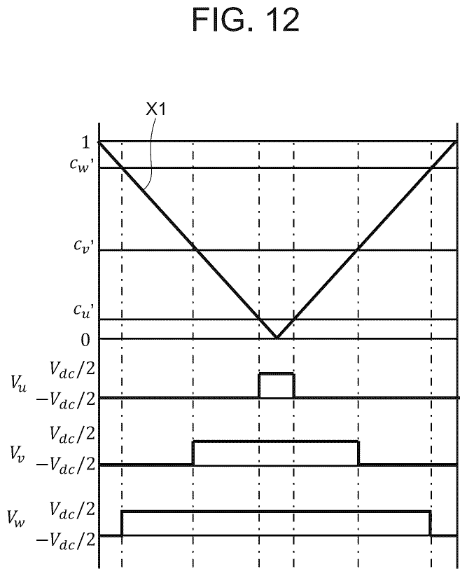

Next, the PWM signal generation unit 36 generates, based on the discontinuous modulation pulse width command values Cu′, Cv′, and Cw′ operated and calculated by the inter-line modulation operation unit 34, PWM signals Vu, Vv, and Vw serving as drive command signals for the U-phase inverter 190, the V-phase inverter 19V, and the W-phase inverter 19W of the inverter circuit 28 by comparing their magnitudes with a carrier triangular wave X1. Although FIG. 12 shows this situation, this is not the period of the above-described phase.

The gate driver 37 generates, based on the PWM signals Vu, Vv, and Vw output from the PWM signal generation unit 36, gate voltages Vou and Vul of the switching elements 18A and 18D of the U-phase inverter 190, gate voltages Vvu and Vvl of the switching elements 18B and 18E of the V-phase inverter 19V, and gate voltages Vwu and Vwl of the switching elements 18C and 18F of the W-phase inverter 19W. These gate voltages Vuu, Vul, Vvu, Vvl, Vwu, and Vwl can be represented by a duty which is a time ratio of an ON state in a predetermined time.

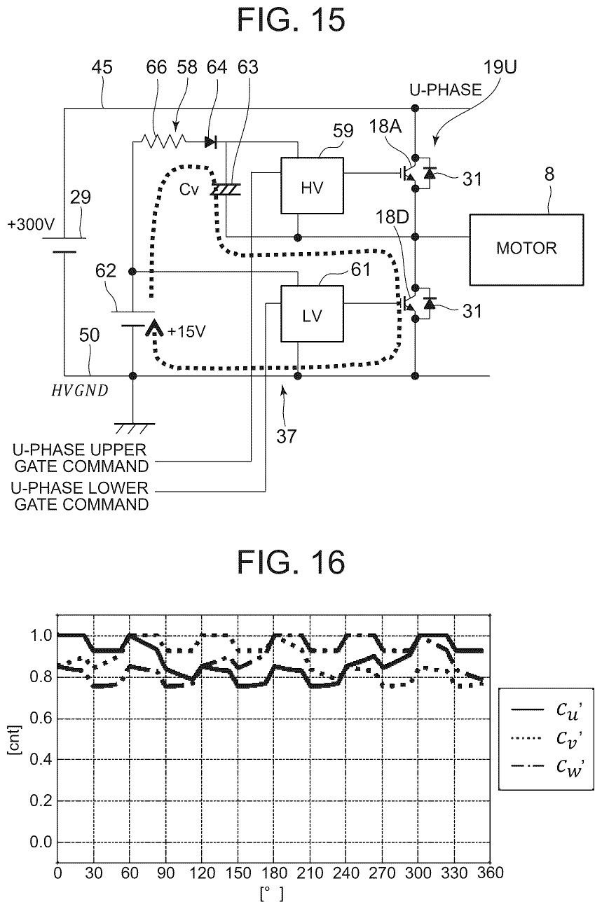

Then, the respective switching elements 18A to 18F of the inverter circuit 28 are ON/OFF driven based on the gate voltages Vuu, Vul, Vvu, Vvl, Vwu, and Vwl output from the gate driver 37. That is, when the gate voltage is brought into an ON state (predetermined voltage value), the transistor is ON-operated. When the gate voltage is brought into an OFF state (zero), the transistor is OFF-operated. When the switching elements 18A to 18F are the aforementioned IGBTs, the gate driver 37 is a circuit for applying the gate voltage to each IGBT based on the PWM signal, and in addition to a bootstrap circuit 58 to be described later, the gate driver 37 has an upper arm gate drive circuit 59 and a lower arm gate drive circuit 61 each comprised of an insulating circuit and a push-pull circuit (photocoupler, logic IC, transistor, etc.) (both shown in FIG. 15). Note that the bootstrap circuit 58 and the respective gate drive circuits 59 and 61 will be described in detail later.

### (7) Effect of Thickness Dimension of Sheet 26 for Lower Arm Switching Elements 18D to 18F

As described above, although large parasitic capacitances (intermediate capacitance) of several tens of pF to several hundreds of pF exist in the arm midpoint having an adverse effect on the EMI noise, that is, between the collector electrode 42 of each of the lower arm switching elements 18D to 18F and the partition wall 3 (chassis 2: heatsink), in the embodiment, the thickness dimension H1 of the sheet 26 interposed between each of the lower arm switching elements 18D to 18F and the partition wall 3 is set to the value larger than the thickness dimension H2 of the sheet 26 interposed between each of the upper arm switching elements 18A to 18C and the partition wall 3 (H2<H1), and the dielectric constant between each of the lower arm switching elements 18D to 18F and the partition wall 3 is made smaller than that between each of the upper arm switching elements 18A to 18C and the partition wall 3 (the parasitic capacitance between each of the lower arm switching elements 18D to 18F and the partition wall 3 is made smaller than that between each of the upper arm switching elements 18A to 18C and the partition wall 3).

This makes it possible to significantly reduce EMI noise due to the common mode current flowing out to the chassis 2 from the arm midpoint (collector electrode 42 of each of the lower arm switching elements 18D to 18F). In particular, in the embodiment, the thickness dimension H1 of the sheet 26 interposed between each of the lower arm switching elements 18D to 18F and the partition wall 3 (chassis 2: heatsink) is set to be larger than the thickness dimension H2 of the sheet 26 interposed between each of the upper arm switching elements 18A to 18C and the partition wall 3 to thereby make the dielectric constant (parasitic capacitance) between each of the lower arm switching elements 18D to 18F and the partition wall 3 smaller than that between each of the upper arm switching elements 18A to 18C and the partition wall 3. Therefore, the conventional sheet can be used as for the sheet 26 for the upper arm switching elements 18A to 180, and the EMI noise can be easily and inexpensively reduced.

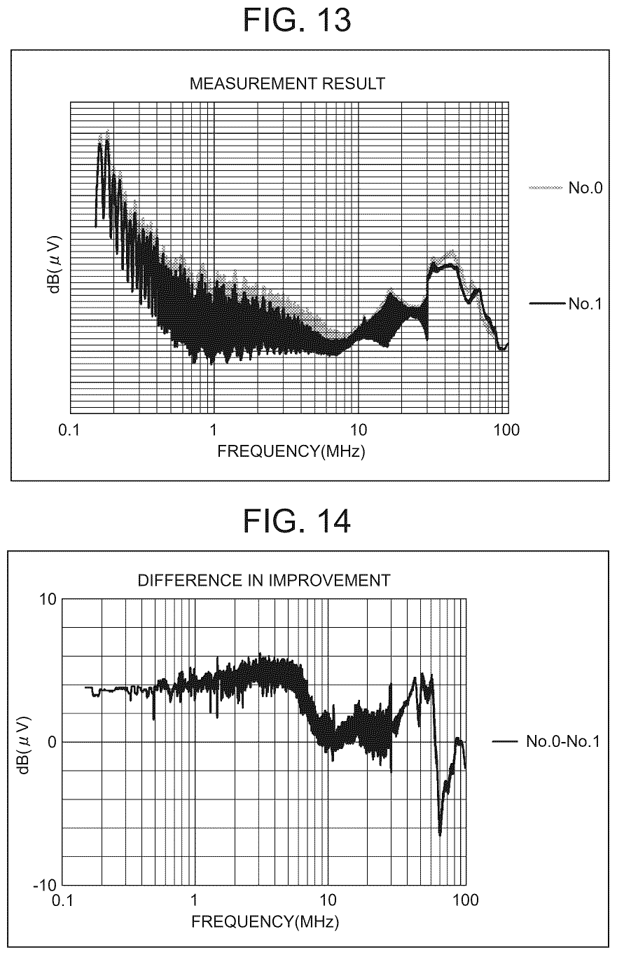

FIG. 13 shows a measurement result (No. 0) of EMI noise due to a common mode current when the thickness dimension H2 of the sheet 26 for the upper arm switching elements 18A to 18C and the thickness dimension H1 of the sheet for the lower arm switching elements 18D to 18F are the same (H2=H1), and a measurement result (No. 1) of EMI noise due to a common mode current when the thickness dimension H1 of the sheet 26 for the lower arm switching elements 18D to 18F is set to three times the thickness dimension H2 of the sheet for the upper arm switching elements 18A to 18C (3×H2=H1), FIG. 14 shows the difference (No. 0-No. 1) between the measurement result. (No. 1) and the measurement result (No. 1).

In FIG. 14, an area above 0 dB means an improved area, As is clear from each figure, it can be seen that when the thickness dimension H1 of the sheet 26 for the lower arm switching elements 18D to 18F is made larger than the thickness dimension H2 of the sheet 26 for the upper arm switching elements 18A to 18C (three times in each figure), a noise reduction effect appears notably in particular below a 10 MHz band.

### (8) Adjustment of Thickness of Sheet 26 for Upper and Lower Arm Switching Elements 18A to 18F

Note that when the wiring lengths between the upper and lower arm switching elements 18A to 18F of each phase and the smoothing capacitor 32 are different, the thickness dimensions H2 and H1 of the sheets 26 for the respective switching elements 18A to 18F may be adjusted and set using the ratio between the wiring length between each of the upper and lower arm switching elements 18A to 18F of each phase and the smoothing capacitor 32 and the parasitic capacitance between each of the lower arm switching elements 18D to 18F and the partition wall 3 (chassis 2: heatsink).

When the balance among the impedance of the inductance of the positive side power supply line 45 extending from the DC power supply 29 to the upper arm switching elements 18A to 18C, the impedance of the inductance of the negative side power supply line 50 extending from the DC power supply 29 to the lower arm switching elements 18D to 18F, and the impedance of the parasitic capacitance between each of the upper and lower arm switching elements 18A to 18F and the chassis 2 is disturbed, EMI noise will increase, However, it becomes easier to maintain impedance balance by adjusting the thickness dimensions Hl and H2 of the sheets 26 and reducing the parasitic capacitance between each of the lower arm switching elements 18D to 18F and the chassis 2 as described above, so that the EMI noise can be effectively reduced. That is, it is also effective as a means for easily removing unnecessary intermediate capacitances when performing impedance balancing.

### (9) Solution to Decrease in Heat Dissipation Performance Due to Increase in Thickness Dimension of Sheet 26 for Lower Arm Switching Elements 18D to 18F

However, the adjustment of the parasitic capacitance by the thickness dimension of the sheet 26 and the heat dissipation performance of each switching element are brought into a trade-off relation, As in the embodiment, when the thickness dimension H1 of the sheet 26 for the lower arm switching elements 18D to 18F is increased, the heat dissipation performance of each of the lower arm switching elements 18D to 18F is reduced.

Therefore, in the embodiment, the heat generation (loss) of the lower arm switching elements 18D to 18F is suppressed by concentrating the heat generation in the upper arm switching elements 18A to 18C with the above-described discontinuous modulation by the inter-line modulation operation unit 34 of the control section 21. Thus, it is possible to supplement the heat dissipation performance of the lower arm switching elements 18D to 18F and avoid the inconvenience of overheating,

Note that even if the heat generation is concentrated in the upper arm switching elements 18A to 180 as described above, there is a possibility that the heat will still be concentrated in the lower arm switching elements 18D to 18F, but in the embodiment, the lower arm switching elements 18D to 18F are arranged upstream of the upper arm switching elements 18A to 18C with respect to the flow of the suction refrigerant in the electric compressor 16 as described above (FIG. 3). Thus, since the lower arm switching elements 18D to 18F are strongly cooled by the lower temperature suction refrigerant, overheating of the lower arm switching elements 18D to 18F is also avoided.

Further, as a result of concentrating the heat generation in the upper arm switching elements 18A to 18C by the discontinuous modulation as in the embodiment, when the heat is too concentrated in the upper arm switching elements 18A to 18C, the discontinuous modulation is not performed, or the zero-phase voltage to be added may be reduced so that the state between FIG. 8 and FIG. 10 is reached.

### (10) Measures for Controlling Bootstrap Circuit 58 of Gate Driver 37

Next, a description will be made about measures for controlling the bootstrap circuit 58 of the gate driver 37 with reference to FIG. 15. Note that in FIG. 15, the same reference numerals as in FIG. 1 denote the same components. Further, although only the U phase is shown in FIG, 15, it is assumed that the V phase and the W phase also have the same circuit configuration.

In the figure, designated at 58 is the above-described bootstrap circuit, designated at 59 is the above-described upper arm gate drive circuit, and designated at 61 is the above-described lower arm gate drive circuit (all for U-phase). The upper arm gate drive circuit 59 generates the above-described gate voltage Vuu based on a U-phase upper gate command generated inside the gate driver 37 and applies the same to the gate of the upper arm switching element 18A, and is connected to a DC 15V power supply 62 via the bootstrap circuit 58. Further, the lower arm gate drive circuit 61 generates the above-described gate voltage Vul based on a U-phase lower gate command generated inside the gate driver 37 and applies the same to the gate of the lower arm switching element 18D, and is connected to the DC 15V power supply 62.

On the other hand, the bootstrap circuit 58 is comprised of a bootstrap capacitor 63 (bootstrap capacitor for switching the upper arm switching element), a diode 64, and a current limiting resistor 66 and is connected between the upper arm gate drive circuit 59 and the DC 15V power supply 62 as shown in FIG. 15. Here, assuming that the upper and lower arm switching elements 18A and 18D are IGBTs which require a gate voltage of 15V, the gate voltage Vul for driving the lower arm switching element 18D may be +15V with respect to HVGND (chassis), and it can hence be driven without any special measures.

On the other hand, in order to drive the upper arm switching element 18A, the gate voltage Vuu of the upper arm switching element 18A needs to be +15V with respect to the arm midpoint connected to the motor 8. Therefore, the bootstrap circuit 58 is used to generate +15V for driving the upper arm switching element 18A.

When the lower arm switching element 18D is turned ON, and the upper arm switching element 18A is turned OFF in FIG. 15, the voltage at the arm midpoint becomes HVGND, and a current flows through a path indicated by a broken line arrow in the figure, so that the bootstrap capacitor 63 is charged. Next, the lower arm switching element 18D is turned OFF, and the upper arm switching element 18A is turned ON. By doing so, the gate voltage Vuu of the upper arm switching element 18A is held at a potential 15V higher than the voltage at the arm midpoint.

However, when the upper arm switching element 18A continues to be in the ON state, the electric charge in the bootstrap capacitor 63 is discharged, and the potential thereof becomes lower than the potential required to drive the upper arm switching element 18A. In order to avoid it, there is a need to periodically turn ON the lower arm switching element 18D.

In the case of the normal sinusoidal modulation, since the lower arm switching element 18D is turned ON/OFF at a specified switching frequency (e.g., 20 kHz for the electric compressor 16), the bootstrap capacitor 63 only needs to have a capacity that can secure a potential required for only 50 μs, for example, Further, the bootstrap capacitors 63 are required for three phases of UVW, and need to be arranged in the vicinity of the upper and lower arm switching elements 18A to 18F and the gate drive circuits 59 and 61. Therefore, especially in the electric compressor 16, the place where it can be arranged is limited, and a capacitor of large capacity cannot be used.

However, when the upper arm switching elements 18A to 18C are continuously brought into the ON state in the discontinuous modulation as described above, and the conduction time is made longer, the lower arm switching element 18D is not turned ON in the sections from 0° to 60° and 300° to 360° in the example of the U phase in FIG. 11. Thus, it is not possible to charge the bootstrap capacitor 63 during the sections. Therefore, unless the capacitance of bootstrap capacitor 63 is increased, the above-described discontinuous modulation cannot be performed especially during the low-speed driving, thus resulting in an extremely disadvantageous problem in the electric compressor 16.

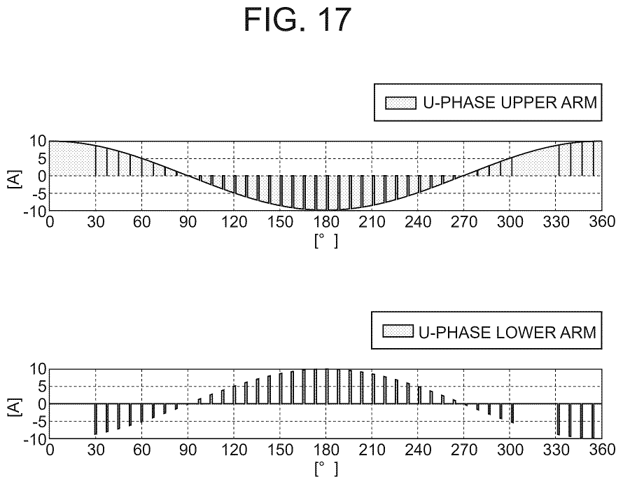

In order to solve this problem, the inter-line modulation operation unit 34 of the control section 21 in the present invention periodically combines the discontinuous modulation shown in FIGS, 10 and 11 with the zero-phase voltage addition control. Specifically, as shown in FIGS. 16 and 17, for example, 0.1 cnt (same value) is subtracted from the three-phase pulse width command values Cu′, Cv′, and Cw′ approximately every 30° to periodically provide a period during which the lower arm switching elements 18D to 18F are turned ON. The ON period for the lower arm switching elements 18D to 18F is periodically provided in this way. Thus, while suppressing an increase in the conduction time of each of the lower arm switching elements 18D to 18F, the charging time for the bootstrap capacitor 63 is secured, and the discontinuous modulation that makes the conduction time of each of the upper arm switching elements 18A to 18C longer is realized without hindrance.

Incidentally, although an example is shown in FIGS. 16 and 17, the timing of subtraction from the pulse width command values Cu′, Cv′, and Cw′ may be arbitrary and may be determined depending on the capacitance of the bootstrap capacitor 63 and the number of revolutions. Further, when the discontinuous modulation is not involved, subtraction may be conducted over the entire 360° range.

Further, in the embodiment, the switching elements each made of the IGBT have been described, but a MOSFET may also be used. Furthermore, in the embodiment, the present invention is applied to the power conversion device 1 which drives and controls the motor 8 of the electric compressor 16, and the heatsink is used as the chassis 2 (partition wall 3) of the electric compressor 16, but the present invention is not limited thereto. The present invention is effective for various power conversion devices each of which applies a voltage at a connection point of upper and lower arm switching elements to a load.

### Description of Reference Numerals

1 power conversion device
2 chassis (heatsink)
3 partition wall
8 motor
16 electric compressor
18A to 18F switching element
19U U-phase inverter
19V V-phase inverter
19W W-phase inverter
21 control section
26 sheet
28 three-phase inverter circuit
33 phase voltage command operation unit
34 inter-line modulation operation unit
36 PWM signal generation unit
37 gate driver
42 collector electrode
43 emitter electrode
44 gate electrode
47 heat spreader
63 bootstrap capacitor.

1. A power conversion device which applies a voltage at a connection point of upper and lower arm switching elements to a load,
wherein a parasitic capacitance between the lower arm switching element and a heatsink is smaller than a parasitic capacitance between the upper arm switching element and the heatsink.

2. A power conversion device which applies a voltage at a connection point of upper and lower arm switching elements to a load,
wherein a dielectric constant between the lower arm switching element and a heatsink is smaller than a dielectric constant between the upper arm switching element and the heatsink.

3. The power conversion device according to claim 1, including insulating and/or heat dissipating sheets interposed between the upper and lower arm switching elements and the heatsink,
wherein the sheet interposed between the lower arm switching element and the heatsink is larger in thickness dimension than the sheet interposed between the upper arm switching element and the heatsink.

4. The power conversion device according to claim 3, including a control device which controls switching of the upper and lower arm switching elements,
wherein the control device makes a conduction time of the upper arm switching element longer than a conduction time of the lower arm switching element.

5. The power conversion device according to claim 4, including the upper and lower arm switching elements of multiple phases,
wherein the control device adds an equal voltage to a command voltage for switching the upper and lower arm switching elements of each phase to make the conduction time of the upper arm switching element longer.

6. The power conversion device according to claim 5, wherein the control device includes a bootstrap capacitor for switching the upper arm switching element, and controls the voltage to be added to secure a charging time for the bootstrap capacitor.

7. The power conversion device according to claim 1, including a cooling device which cools the upper and lower arm switching elements,
wherein the lower arm switching element is arranged so as to receive a stronger cooling effect from the cooling device than the upper arm switching element.

8. The power conversion device according to claim 1, which applies a phase voltage at a connection point of the three-phase upper and lower arm switching elements to a motor which drives a compression mechanism of an electric compressor,
wherein the upper and lower arm switching elements of each phase are arranged in a heat exchange relation with a refrigerant sucked into the electric compressor, and the lower arm switching element is arranged on the upstream side of the sucked refrigerant than the upper arm switching element.

9. The power conversion device according to claim 3, including the upper and lower arm switching elements of multiple phases,
wherein the thickness of the sheet is set by using the ratio between a wiring length between each of the upper and lower arm switching elements of each phase and a smoothing capacitor and the parasitic capacitance between the lower arm switching element and the heatsink.

10. The power conversion device according to claim 9, wherein the impedance of an inductance of a path from a DC power supply to each of the upper and lower arm switching elements of each phase, and the impedance of a parasitic capacitance between each of the upper and lower arm switching elements and the heatsink are balanced.
